(19) United States
(12) Patent Application Publication
(10) Pub. No.: US 2022/0414171 A1
(43) Pub. Date: Dec. 29, 2022

(54) SYSTEM AND METHOD FOR GENERATING A USER QUERY BASED ON A TARGET CONTEXT AWARE TOKEN

(71) Applicant: Flipkart Internet Private Limited, Bengaluru (IN)

(72) Inventors: Pooja Macharanda KUSHALAPPA, Bangalore (IN); Krishna Azad TRIPATHI, Jaipur (IN); Praneet Ashok MEHTA, Ratlam (IN); Pranjal SANJANWALA, Umbergaon Town (IN)

(73) Assignee: Flipkart Internet Private Limited, Bengaluru (IN)

(21) Appl. No.: 17/846,516

(22) Filed: Jun. 22, 2022

(30) Foreign Application Priority Data
Jun. 28, 2021 (IN) 202141028910

(51) Int. Cl. G06F 16/9535; G06F 16/951; G06F 40/284; G06F 16/242

(52) U.S. Cl. CPC G06F 16/9535; G06F 16/951; G06F 40/284; G06F 16/242

(57) ABSTRACT

A system and method for generating a user query based on a target context aware token. The method encompasses initiating, by a processing unit [102], a search engine. The method further comprises receiving, via an input unit [104], a user input at the search engine. The method further recommends, by the processing unit [102], a set of context aware tokens based at least on the user input. Further the method encompasses selecting, by the processing unit [102], a target context aware token from the set of context aware tokens based on a user selection. The method thereafter comprises appending, by the processing unit [102], the target context aware token to the user input in the search engine. Further the method comprises generating, by the processing unit [102], the user query based on appending the target context aware token to the user input.

### TECHNICAL FIELD

The present invention generally relates to recommendation systems and more particularly to systems and methods for generating a user query based on a target context aware token.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Over the past few years digital technologies are enhanced to a great extent and with an immense growth in the field of digital technologies, a number of facilities are provided to the users of electronic devices. Various digital platforms such as social media platforms, e-commerce platforms, mobile commerce platforms, various websites etc. facilitates the users with various recommendations to provide user input(s). These recommendations are generally related to auto completion and/or autosuggestion of the user inputs, and are primarily focused on suggesting the popular queries/inputs already suggested by the users. For instance, if on a particular digital platform most of the users searches a query ‘how to capture a photograph’ and in the given instance if a user provides an input ‘how to capture’ in a search engine/search bar of said digital platform, an auto completion recommendation ‘a photograph’ may be suggested to the user to complete the user/search query or the search query ‘how to capture a photograph’ may be directly suggested to the user as autosuggestion of the user input. Also, some of the known solutions provides recommendations based on users past purchases or user's preferences. For instance, if a user prefers to buy a bottle of a brand ABC and in an event if such user provides the word ‘ABC’ as an input on an e-commerce platform to search a product, the word ‘bottle’ may be provided to the user as a recommendation based on the user's past purchases or user's preference as autosuggestion to complete the user query to buy the product. Some of the other known recommendation solutions provides as recommendation(s) a grammar/spelling based auto completion and/or autosuggestion texts to provide user input(s). For instance, if a user provided a word ‘automa’ as a user input, a recommendation ‘automatic’ may be provided to the user to provide the user input.

The recommendations provided by currently known solutions to build a user query are not efficient and provides poor user interaction/experience. Presently, there are no solutions which can suggest token level recommendations to build a user query. Also, the current solutions fails to aid the user(s) to map search terms to various datasets such as e-commerce catalogs to find right product(s), by understanding search term(s) of the user queries and mapping it to right catalog terms. The current autosuggest solutions are solely driven by queries of the user(s) i.e. be it past user queries or custom made queries and there is no token level query builder with the help of suggestions itself.

Therefore, there is a need in the art to provide token level suggestions to the user(s) in order to efficiently and effectively generate a user query based on one or more context aware tokens.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for generating a user query based on a target context aware token. Another object of the present invention is to provide a unique user experience in a search space by suggesting a plurality of context aware tokens to build a user/search query. Also, an object of the present invention is to suggest a next possible set of the context aware tokens (i.e. updated context aware tokens) which a user may select in order to formulate a final search query. Another object of the present invention is to upgrade the user experience in an e-commerce autosuggestion space. Also an object of the present invention is to map one or more search queries of one or more users to catalog terms associated with a digital platform, to provide the user(s) various options/token level recommendations for searching one or more catalog items on said digital platform. Another object of the present invention is to provide reduction of articulation gap, by mapping the one or more users' queries to an e-commerce platform catalog. Also, an object of the present invention is to reduce the one or more users' misspellings and to provide uniform creation of search queries that enable in reduction of search pain. Yet another object of the present invention is to aid in diversity and providing easier choices to the one or more users to build a search/user query.

Furthermore, in order to achieve the aforementioned objectives, the present invention provides a method and system for generating a user query based on a target context aware token.

A first aspect of the present invention relates to the method for generating a user query based on a target context aware token. The method encompasses initiating, by a processing unit, a search engine at a user device. The method further comprises receiving, via an input unit, a user input at the search engine. The method further leads to recommending, by the processing unit, a set of context aware tokens based at least on the user input, wherein the set of context aware tokens comprises a plurality of context aware tokens. Further the method encompasses selecting, by the processing unit, a target context aware token from the plurality of context aware tokens based on a user selection of the target context aware token. The method thereafter comprises appending, by the processing unit, the target context aware token to the user input in the search engine. Further the method comprises generating, by the processing unit, the user query based on appending the target context aware token to the user input.

Another aspect of the present invention relates to a system for generating a user query based on a target context aware token. The system comprises a processing unit, configured to initiate, a search engine at a user device. The system further comprises an input unit, configured to receive, a user input at the search engine. Also, the processing unit is further configured to recommend, a set of context aware tokens based at least on the user input, wherein the set of context aware tokens comprises a plurality of context aware tokens. Thereafter the processing unit is configured to select, a target context aware token from the plurality of context aware tokens based on a user selection of the target context aware token. Further the processing unit is configured to append, the target context aware token to the user input in the search engine. The processing unit is thereafter configured to generate, the user query based on appending the target context aware token to the user input.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for generating a user query based on a target context aware token, in accordance with exemplary embodiments of the present invention.

FIG. 2 illustrates an exemplary method flow diagram [200], for generating a user query based on a target context aware token, in accordance with exemplary embodiments of the present invention.

FIG. 3 illustrates an exemplary method flow diagram [300], for generating an updated user query based on an updated context aware token, in accordance with exemplary embodiments of the present invention.

FIG. 4 illustrates an exemplary use case for generating a user query and an updated user query, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a user, a processing unit, an input unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section the existing technologies have many limitations and in order to overcome at least some of the limitations of the prior known solutions, the present disclosure provides a solution for generating a user query based on a user selection of target context aware token. The present invention also provides a solution to update the user query based on a user selection of one or more updated context aware tokens. Also, the present invention provides a solution to provide one or more autosuggested queries/suggestions based on at least one of a user input, the user query and the updated user query.

In order to provide at least the above solutions the present solution recommends one or more users, a set of context aware tokens comprising a plurality of context aware tokens. The one or more users may select a context aware token from the plurality of context aware tokens as a target context aware token to formulate a user query. In an implementation the set of context aware tokens/the plurality of context aware tokens are user input based recommendations that keeps on changing/updating based on a user input received so far at a search engine/search space. Therefore, in such implementation the present invention also recommends a next possible set of incoming context aware tokens (i.e. an updated set of context aware tokens) from which the one or more users may select one or more updated context aware tokens to formulate an updated user query. More particularly, the user query may be updated based on a user selection of an updated context aware token. Also, each of the context aware token and the updated context aware token is generated based on a mapping dataset (such as an e-commerce catalog) and provided as a recommendation to further provide the one or more users different options to build or update one or more user/search queries for searching products based on the mapping dataset/catalog. Based on the selection of at least one of the context aware tokens and the updated context aware tokens, an autosuggest component that suggests one or more closest queries to a user input is also modified to provide better recommendations.

Hereinafter, exemplary embodiments of the present disclosure will be described in detail with reference to the accompanying drawings so that those skilled in the art can easily carry out the present disclosure.

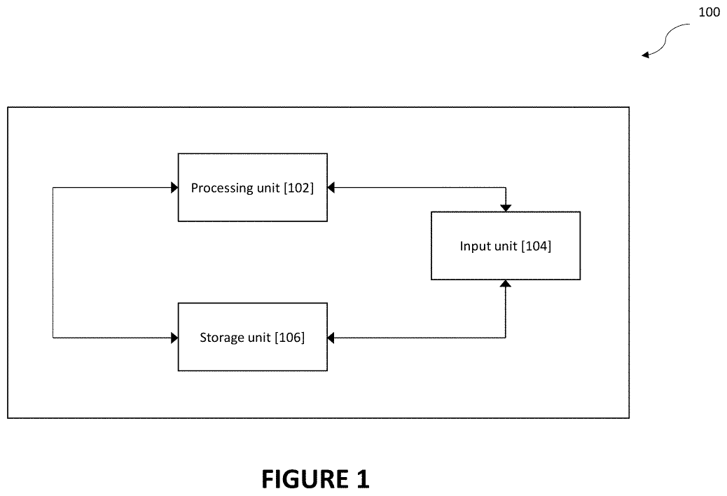

Referring to FIG. 1, an exemplary block diagram of a system [100] for generating a user query based on a target context aware token, in accordance with exemplary embodiments of the present invention is shown.

The system [100] comprises at least one processing unit [102], at least one input unit [104] and at least one storage unit [106]. Also, all of the components/units of the system [100] are assumed to be connected to each other unless otherwise indicated below. Also, in FIG. 1 only a few units are shown, however, the system may comprise multiple such units or the system [100] may comprise any such numbers of said units, as required to implement the features of the present disclosure. Further, in an implementation, the system [100] is connected to a user device of a user to implement the features of the present invention. Also, in yet another implementation the system [100] as a whole or partly, may be present in a server device to implement the features of the present invention.

The system [100] is configured to generate a user query based on a target context aware token, with the help of the interconnection between the components/units of the system [100].

The processing unit [102] of the system [100] is connected at least to the input unit [104] and the storage unit [106] of the system [100]. The processing unit [102] is configured to initiate, a search engine at a user device. More particularly the processing unit [102] is configured to initiate the search engine on a digital platform accessed on the user device. In a preferred implementation the search engine is initiated at an e-commerce platform on the user device. The search engine is initiated to perform at least one search based on a user input, wherein the at least one search may be performed to access an information related to various digital contents such as including but not limited a product related information, a service related information and the like. In an example, the processing unit [102] is configured to initiate a search engine on an e-commerce platform to provide a user a platform to perform a search to access an information related to a product based on a user input, in order to further purchase such product.

The input unit [104] is connected at least to the processing unit [102] and the storage unit [106]. Once the search engine is initiated, the input unit [104] is configured to receive, the user input at the search engine. For example, if a search engine is initiated on an e-commerce platform at a user device, a text ‘Jeans’ as a user input may be received at the search engine via a keyboard (i.e. the input unit) [104]). In another example, a text ‘Jeans’ or ‘Shirts’ etc. may be received as a user input at a search engine initiated at an e-commerce platform via a microphone (i.e. the input unit [104]) using one or more speech to text conversion techniques.

After receiving the user input at the search engine, the processing unit [102] is configured to recommend, a set of context aware tokens based at least on the user input, wherein the set of context aware tokens comprises a plurality of context aware tokens. The plurality of context aware tokens comprises plurality of recommendations that keeps on changing/updating based on the user input received so far. In an example, if a user input text ‘Mobile’ is received at a search engine initiated on an e-commerce platform accessed at a user device to perform a ‘Mobile’ related search, in such instance the plurality of context aware tokens comprises a plurality of ‘Mobile’ related recommendations (i.e. the recommendations are based on the context of the user input received at the search engine).

Furthermore, in order to generate the plurality of context aware tokens the processing unit [102] is firstly configured to identify, one or more whitelisted attributes in the user input. Further, once the one or more whitelisted attributes in the user input are identified, the processing unit [102] is further configured to identify, a set of attributes corresponding to each attribute of the one or more whitelisted attributes based at least on a pre-defined store mapping dataset. In an implementation, a storage unit such as the storage unit [106] or a cloud storage unit connected to the processing unit [102] may store the pre-defined store mapping dataset (such as e-commerce catalog mapping dataset) for the each attribute. Also, in an instance, the set of attributes corresponding to each attribute of the one or more whitelisted attributes comprises top ‘n’ attributes corresponding to the each attribute, wherein such top ‘n’ attributes may be identified based on a product click data and its distribution in said attribute. The processing unit [102] is further configured to determine one or more attribute-attribute pairs based on the identification of the set of attributes corresponding to each attribute of the one or more whitelisted attributes. Thereafter the processing unit [102] is configured to determine, a set of values associated with the each attribute-attribute pair and a corresponding score of the each attribute-attribute pair. Considering the above instance, at this stage, top ‘n’ values corresponding to each attribute-attribute (from the top-′n′ attributes) pair and their scores are identified by the processing unit [102]. Further, the processing unit [102] is configured to determine, all values associated with the each attribute of the one or more whitelisted attributes and a similarity score corresponding to said each attribute based on a knowledge graph. Considering the above instance, at this stage, the processing unit [102] initiates a knowledge graph for the each attribute to receive all the values (on the edges going out corresponding to the top-n attributes found in the previous steps) and their similarity score. Further the processing unit [102] is configured to merge, the set of values associated with each attribute-attribute pair and the corresponding score of the each attribute-attribute pair with the all values associated with the each attribute of the one or more whitelisted attributes and the similarity score. Considering the above instance, at this stage, the processing unit [102] is further configured to merge the top ‘n’ values corresponding to each attribute-attribute (from the top-′n′ attributes) pair and their scores with the all the values for each attribute and their similarity score. The processing unit [102] is thereafter configured to generate, the set of context aware tokens based on said merging.

Once the set of context aware tokens are recommended, the processing unit [102] is further configured to select, a target context aware token from the plurality of context aware tokens based on a user selection of the target context aware token. For example, if 9 context aware tokens related to a user input ‘Mobile’ i.e. ABC, CBA, XYZ, Blue, Black, White, under 5000 INR, above 10000 INR and between 5000 and 10000 INR (wherein ABC, CBA and XYZ indicates brands, Blue, Black and White indicates colors and under 5000 INR, above 10000 INR and between 5000 and 10000 INR indicates price range) are recommended to a user based on a receipt of the text ‘Mobile’ as the user input on a search engine initiated at an e-commerce platform. In the given example, the user may select the recommended context aware token ‘Blue’ from the recommended 9 context aware tokens and the processing unit [102] based on the user selection of said ‘Blue’ context aware token selects ‘Blue’ as a target context aware token.

Further the processing unit [102] is configured to append, the target context aware token to the user input in the search engine. Considering the above example, where the user input is text ‘Mobile’ and the target context aware token is ‘Blue’, the processing unit [102] is further configured to append the target context aware token ‘Blue’ with the user input text ‘Mobile’ in the search engine initiated at the e-commerce platform.

The processing unit [102] is further configured to generate, the user query based on appending the target context aware token to the user input. For instance, in the above example, based on appending the target context aware token ‘Blue’ with the user input text ‘Mobile’, the processing unit [102] is configured to generate ‘Mobile Blue’ as a user query.

Further, the processing unit [102] is also configured to dynamically update the set of context aware tokens based on the user query to generate an updated set of context aware tokens, wherein the updated set of context aware tokens comprises at least, one or more updated context aware tokens. Furthermore, the one or more updated context aware tokens are generated based at least on one or more whitelisted attributes present in the user query. More particularly, once the user query is generated it acts a new user input at the search engine and the processing unit [102] based on such new user input is further configured to generate the updated set of context aware tokens, therefore the plurality of context aware tokens keeps on changing/updating to generate updated set of context aware tokens based on a change in the user input. The one or more updated context aware tokens are generated in a similar manner as that of generation of the plurality of context aware tokens, therefore the steps are not repeated here. For example, when a user input is received at a search engine, the processing unit [102] is configured to identify a whitelisted attribute in the received user input. Thereafter, the processing unit [102] is configured to match attribute(s) corresponding to the identified whitelisted attribute based at least on the pre-defined store mapping dataset, in order to further recommend a set of context aware tokens. In the given example if the user input is “jeans” and the identified whitelisted attribute is a vertical, the processing unit [102] is configured to recommend the set of context aware tokens based on a matching of attribute(s) corresponding to the vertical “jeans”, wherein the set of context aware tokens comprises a plurality of context aware tokens such as:
1. Different colours in which jeans are available—blue, black, etc.
2. Different sizes—L, XL, etc.
3. Different genders for which jeans are available—Men, Women

Now, if the user selects ‘Men’ from the available set of context aware tokens, an updated set of context aware tokens is provided to the user basis the initial attribute/user input (here, jeans) and the first selected context aware token (here, ‘Men’). In this case, context aware tokens related to different styles in jeans (i.e. updated context aware tokens) may be shown as—e.g. Skinny, Tapered, etc.

Also, considering the above example, where ‘Mobile Blue’ is generated as the user query, the text ‘Mobile Blue’ in the search engine will act as a new user input and therefore the processing unit based on said new input is configured to generate for example 9 context aware tokens i.e. ABC, CBA, XYZ, 10 MP camera, 20 MP camera 40 MP camera, under 5000 INR, above 10000 INR and between 5000 and 10000 INR as the updated the set of context aware tokens, wherein ABC, CBA and XYZ indicates brands, 10 MP camera, 20 MP camera 40 MP camera indicates camera specification and under 5000 INR, above 10000 INR and between 5000 and 10000 INR indicates price range.

In an implementation if a final search action is performed by the user based on the generated user query, one or more results are provided to the user based on such final search action. For instance, in the above example where the user query is ‘Mobile Blue’, if a final search action is performed by the user based on the user query ‘Mobile Blue’, one or more results are provided to the user based on search query ‘Mobile Blue’.

In another implementation, if the final search action is not performed by the user based on the generated user query, the processing unit [102] is configured to select, an updated context aware token from the updated set of context aware tokens based on a user selection of the updated context aware token. Thereafter, the processing unit [102] is configured to append, the updated context aware token to the user query in the search engine. The processing unit [102] is then configured to modify, the user query based on appending the updated context aware token to the user query, and the processing unit [102] is further configured to generate, an updated user query based on the modified user query. Considering the above example, where 9 context aware tokens i.e. ABC, CBA, XYZ, 10 MP camera, 20 MP camera 40 MP camera, under 5000 INR, above 10000 INR and between 5000 and 10000 INR are generated as the update the set of context aware tokens, the processing unit [102] in such instance is configured to recommend these update the set of context aware tokens. Further, based on a user selection of an update context aware token say 10 MP camera, the processing unit [102] is configured to append ‘10 MP camera’ to the user query ‘Mobile Blue’ to modify the user query ‘Mobile Blue’. The processing unit [102] is thereafter configured generated ‘Mobile Blue 10 MP camera’ as an updated user query based on the modified user query ‘Mobile Blue’.

Further in an implementation the final search action may be performed by the user based on the updated user query to receive one or more final search results based on such final search action. Also, in another implementation if the final search action is not performed by the user based on the updated user query, the processing unit [102] may be configured to select, a further updated context aware token from a further updated set of context aware tokens based on a user selection of the further updated context aware token. More particularly, in such implementation once the updated user query is generated it acts a new user input at the search engine and the processing unit [102] based on such new user input is further configured to generate the further updated set of context aware tokens. Based on the implementation of the features of the present invention the processing unit [102] is configured to perform the process of updating the context aware tokens to generate updated set of context aware tokens every time an updated/changed user input/user query is received at the search engine till the final search action is performed by the user.

Also, the processing unit [102] is further configured to provide one or more autosuggested queries based on at least one of the user input, the user query and the updated user query. The one or more autosuggested queries are one or more autosuggested search queries recommended to the user in an autosuggested search space based on at least one of the user input, the user query and the updated user query. In an implementation the one or more autosuggested search query comprises a usual autosuggest component which suggest one or more closest queries to at least one of the user input, the user query and the updated user query.

In an implementation the processing unit [102] is also configured to recommend an initial set of context aware tokens based on initiating the search engine at the user device, wherein the initial set of context aware tokens comprises a plurality of recommended whitelisted attributes. Also, the plurality of recommended whitelisted attributes are determined based on a score associated with each recommended whitelisted attribute. More particularly, in an event the search engine is initiated at the user device and no user input is received at the search engine, the processing unit [102] in such event is configured to recommend the initial set of context aware tokens comprising the plurality of recommended whitelisted attributes. In an implementation, the plurality of recommended whitelisted attributes are determined based on a popularity score associated with each recommended whitelisted attribute, wherein the popularity score may be determined based on a user click rate corresponding to the each recommended whitelisted attribute and the like.

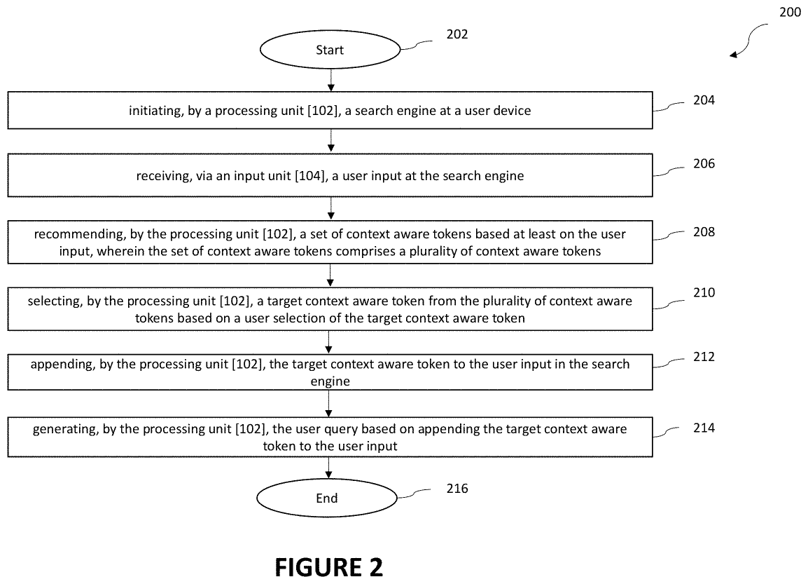

Referring to FIG. 2 an exemplary method flow diagram [200], for generating a user query based on a target context aware token, in accordance with exemplary embodiments of the present invention is shown. In an implementation the method is performed on an electronic/user device by system [100]. Further, in an implementation, the system [100] as a whole or partly, may be present in a server device to implement the features of the present invention. Also, as shown in FIG. 2, the method starts at step [202].

At step [204] the method comprises initiating, by a processing unit [102], a search engine at the user device. More particularly, the method encompasses initiating by the processing unit [102], the search engine on a digital platform accessed on the user device. In a preferred implementation the search engine is initiated at an e-commerce platform on the user device. The search engine is initiated to perform at least one search based on a user input, wherein the at least one search may be performed to access an information related to various digital contents such as including but not limited a product related information, a service related information and the like. In an implementation, the method encompasses initiating, by the processing unit [102], a search engine on an e-commerce platform to provide a user a platform to perform a search to access an information related to one or more products based on a user input, in order to further purchase such one or more products.

Next at step [206] the method comprises receiving, via an input unit [104], the user input at the search engine. For instance, if a search engine is initiated on an e-commerce platform at a user device, the method may comprises receiving a text ‘Laptop’ as a user input, at the search engine via a keyboard (i.e. the input unit) [104]). In another example, the method may comprises receiving a text ‘Battery’ or ‘Charger’ etc., as a user input, at a search engine initiated at an e-commerce platform via a microphone (i.e. the input unit [104]) using one or more speech to text conversion techniques.

Further, at step [208] the method comprises recommending, by the processing unit [102], a set of context aware tokens based at least on the user input, wherein the set of context aware tokens comprises a plurality of context aware tokens. The plurality of context aware tokens comprises plurality of recommendations that keeps on changing/updating based on the user input received so far at the search engine. In an example, if a user input text ‘Watch’ is received at a search engine initiated on an e-commerce platform accessed at a user device to perform a ‘Watch’ related search, in such instance the plurality of context aware tokens comprises a plurality of ‘Watch’ related recommendations (i.e. the recommendations are based on the context of the user input received at the search engine).

Furthermore, the plurality of context aware tokens are generated based on firstly identifying, by the processing unit [102], one or more whitelisted attributes in the user input. Thereafter, the process leads to identifying, by the processing unit [102], a set of attributes corresponding to each attribute of the one or more whitelisted attributes based at least on a pre-defined store mapping dataset. In an implementation, a storage unit such as the storage unit [106] or a cloud storage unit connected to the processing unit [102] may store the pre-defined store mapping dataset (such as e-commerce catalog mapping dataset) for the each attribute. Also, in an instance, the set of attributes corresponding to each attribute of the one or more whitelisted attributes comprises top ‘n’ attributes corresponding to the each attribute, wherein such top ‘n’ attributes may be identified based on a product click data and its distribution in said attribute. The process thereafter leads to determining, by the processing unit [102], one or more attribute-attribute pairs based on the identification of the set of attributes corresponding to each attribute of the one or more whitelisted attributes. Further the process encompasses determining, by the processing unit [102], a set of values associated with the each attribute-attribute pair and a corresponding score of the each attribute-attribute pair. In the above instance, at this stage top ‘n’ values corresponding to each attribute-attribute (from the top-′n′ attributes) pair and their scores are identified by the processing unit [102]. Thereafter, the process encompasses determining, by the processing unit [102], all values associated with the each attribute of the one or more whitelisted attributes and a similarity score corresponding to the each attribute based on a knowledge graph. Considering the above instance, at this step, a knowledge graph is initiated by the processing unit [102] for each attribute to receive all the values (on the edges going out corresponding to the top-n attributes found in the previous steps) and their similarity score. Thereafter the process encompasses merging, by the processing unit [102], the set of values associated with each attribute-attribute pair and the corresponding score of the each attribute-attribute pair with the all values associated with the each attribute and the similarity score. Considering the above instance, at this stage the top ‘n’ values corresponding to each attribute-attribute (from the top-′n′ attributes) pair and their scores are merged with the all the values for the each attribute and their similarity score. The process thereafter comprises generating, by the processing unit [102], the set of context aware tokens based on the merging.

Once the set of context aware tokens are recommended, the method at step [210] comprises selecting, by the processing unit [102], a target context aware token from the plurality of context aware tokens based on a user selection of the target context aware token. For example, if 9 context aware tokens related to a user input ‘Laptop’ i.e. AAA, BBB, CCC, Blue, Black, White, under 50000 INR, above 100000 INR and between 50000 and 100000 INR (wherein AAA, BBB and CCC indicates brands, Blue, Black and White indicates colors and under 5000 INR, above 10000 INR and between 5000 and 10000 INR indicates price range) are recommended to a user based on a receipt of the text ‘Laptop’ as the user input on a search engine initiated at an e-commerce platform. In the given example, the user may select the recommended context aware token ‘AAA’ from the recommended 9 context aware tokens and the method encompasses selecting by the processing unit [102] ‘AAA’ as a target context aware token, based on the user selection of said ‘AAA’ context aware token.

Next, at step [212] the method comprises appending, by the processing unit [102], the target context aware token to the user input in the search engine. Considering the above example, where the user input is text ‘Laptop’ and the target context aware token is ‘AAA’, the method encompasses appending by the processing unit [102], the target context aware token ‘AAA’ with the user input text ‘Laptop’ in the search engine initiated at the e-commerce platform.

Further, at step [214] the method comprises generating, by the processing unit [102], the user query based on appending the target context aware token to the user input. For instance, in the above example, based on appending the target context aware token ‘AAA’ with the user input text ‘Laptop’, the method encompasses generating by the processing unit ‘Laptop AAA’ as a user query.

The method further comprises dynamically updating by the processing unit [102], the set of context aware tokens based on the user query to generate an updated set of context aware tokens, wherein the updated set of context aware tokens comprises at least, one or more updated context aware tokens. The one or more updated context aware tokens are generated based at least on one or more whitelisted attributes present in the user query. More particularly, once the user query is generated it acts a new user input at the search engine and the method encompasses generating by the processing unit [102] the updated set of context aware tokens based on such new user input, therefore the plurality of context aware tokens keeps on changing/updating to generate updated set of context aware tokens based on a change in the user input. Furthermore, the one or more updated context aware tokens are generated in a similar manner as that of generation of the plurality of context aware tokens, therefore the steps are not repeated here. Further, considering the above example, where ‘Laptop AAA’ is generated as the user query, the text ‘Laptop AAA’ in the search engine will act as a new user input and therefore the method based on said new input encompasses generating by the processing unit 9 updated context aware tokens for instance: 16 GB RAM, 8 GB RAM, 4 GB RAM, Blue, White, Black, under 50000 INR, above 100000 INR and between 50000 and 100000 INR, wherein 16 GB RAM, 8 GB RAM, 4 GB RAM indicates memory specifications, Blue, White, Black, indicates color and under 50000 INR, above 100000 INR and between 50000 and 100000 INR indicates price range.

In an implementation if a final search action is performed by the user based on the generated user query, one or more results are provided to the user based on such final search action. For instance, in the above example if a final search action is performed by the user based on the user query ‘Laptop AAA’, one or more results are provided to the user based on search query ‘Laptop AAA’.

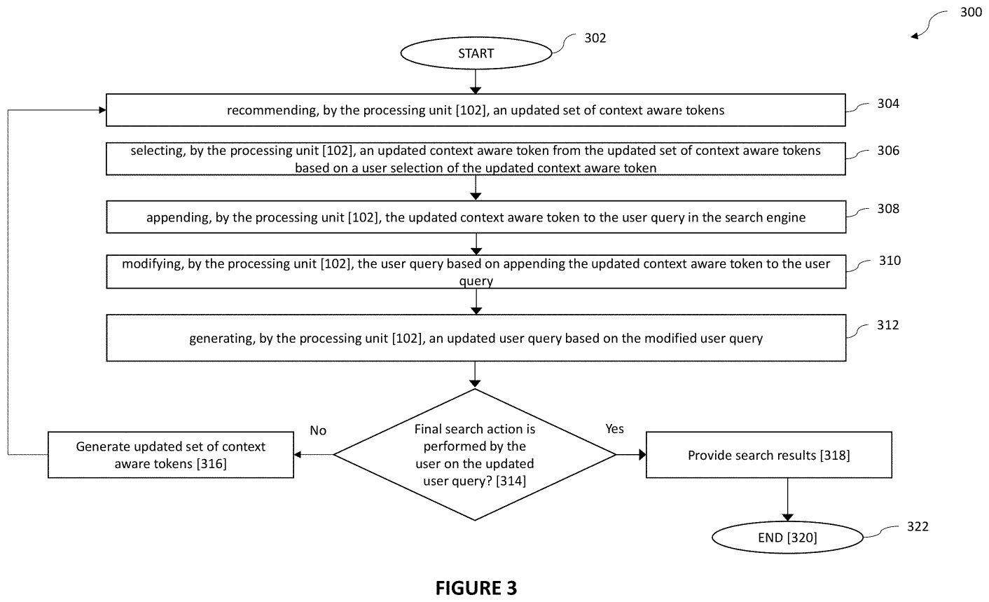

In another implementation, if the final search action is not performed by the user based on the generated user query, the method may comprise generating, by the processing unit [102], an updated user query, which is further explained below in FIG. 3. Also, based on the implementation of the features of the present invention the method via the processing unit [102] encompasses performing the process of updating the context aware tokens to generate updated set of context aware tokens every time an updated/changed user input/user query is received at the search engine till the final search action is performed by the user.

Furthermore, in an implementation the method also comprises providing by the processing unit [102], one or more autosuggested queries based on at least one of the user input and the user query. The one or more autosuggested queries are one or more autosuggested search queries recommended to the user in an autosuggested search space based on at least one of the user input and the user query. In an implementation the one or more autosuggested search queries comprises a usual autosuggest component which suggest one or more closest queries to at least one of the user input and the user query.

Also, in another implementation the method also comprises recommending by the processing unit [102] an initial set of context aware tokens based on initiating the search engine at the user device, wherein the initial set of context aware tokens comprises a plurality of recommended whitelisted attributes. The plurality of recommended whitelisted attributes are determined based on a score associated with each recommended whitelisted attributes. More particularly, in an event the search engine is initiated at the user device and no user input is received at the search engine, in such event the method encompasses recommending by the processing unit [102], the initial set of context aware tokens comprising the plurality of recommended whitelisted attributes. In an implementation, the plurality of recommended whitelisted attributes are determined based on a popularity score associated with each recommended whitelisted attribute, wherein the popularity score may be determined based on a user click rate corresponding to the each recommended whitelisted attribute and the like.

Thereafter, the method terminates at step [216].

Referring to FIG. 3, an exemplary method flow diagram [300], for generating an updated user query based on an updated context aware token, in accordance with exemplary embodiments of the present invention is shown. Also, as shown in FIG. 3, the method starts at step [302].

At step [304] the method comprises recommending, by the processing unit [102], an updated set of context aware tokens. The details of generation of the updated set of context aware tokens are disclosed under description of FIG. 1 and therefore are not repeated under FIG. 3.

At step [306] the method comprises selecting, by the processing unit [102], an updated context aware token from the updated set of context aware tokens based on a user selection of the updated context aware token. For example, if 6 updated context aware tokens i.e. Red, Blue, Green, X, M, and L are recommended as an updated set of context aware tokens based on a user query ‘Formal Shirts’, in such instance, Blue may be selected as an updated context aware token based on a user selection of ‘Blue’.

Next at step [308] the method comprises appending, by the processing unit [102], the updated context aware token to the user query in the search engine. Considering the above example, ‘Blue’ is appended to the ‘Formal Shirts’ in the search engine.

Further at step [310] the method comprises modifying, by the processing unit [102], the user query based on appending the updated context aware token to the user query and at step [312] the method comprises generating, by the processing unit [102], an updated user query based on the modified user query. For instance, considering the above example, ‘Formal Shirts Blue’ is generated as the updated user query.

Next, at step [314] the method encompasses identifying if a final search action is performed by the user based on the updated user query. In case the final search action is performed the method leads to step [318], otherwise the method leads to step [316].

Further, at step [316] the method generates the updated set of context aware tokens based on the updated user query and leads back to the step [304]. The details of generation of the updated set of context aware tokens are disclosed under description of FIG. 1 and therefore are not repeated under FIG. 3.

Also, at step [318], the method encompasses providing the search results based on the final search action and the method leads to step [320]. Considering the above example, if a final search action is performed by the user based on the updated user query ‘Formal Shirts Blue’, corresponding results are provided to the user.

In an implementation the method also comprises providing by the processing unit [102], one or more autosuggested queries based on the updated user query. In an implementation the one or more autosuggested search query comprises a usual autosuggest component which suggest one or more closest queries to the updated user query. If the user performs the final search action based on said one or more autosuggested queries, the search results are provided based on said one or more autosuggested queries.

After providing the search results, the method terminates at step [320].

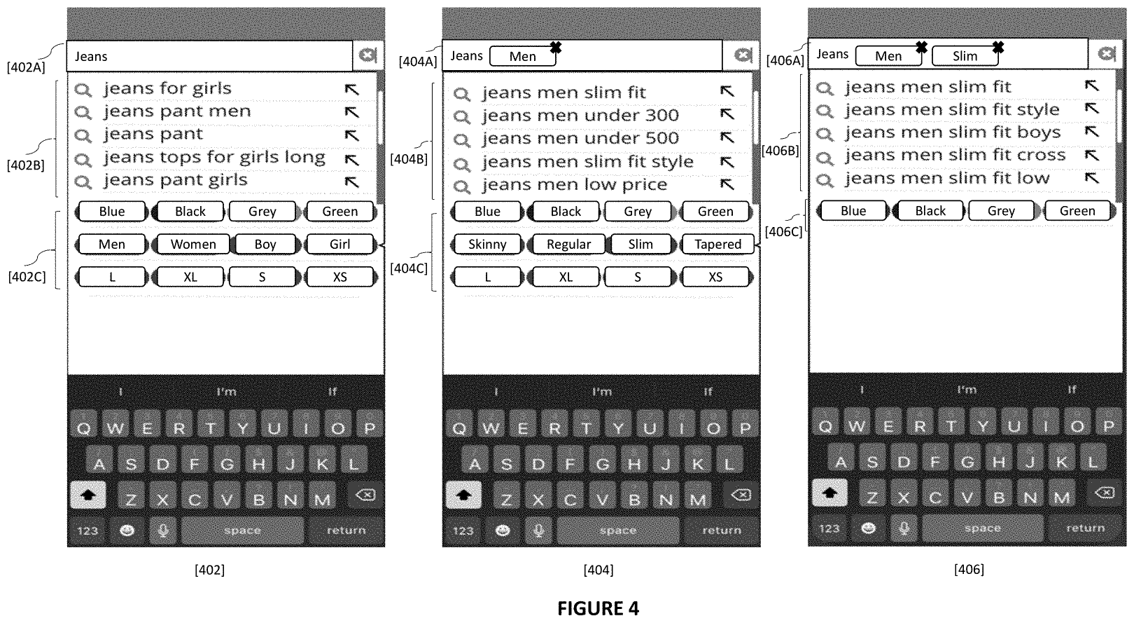

Referring to FIG. 4, an exemplary use case for generating a user query and an updated user query, in accordance with exemplary embodiments of the present invention is shown.

FIG. 4 at [402], [404] and [406] depicts three user interfaces depicting at least a set of context aware tokens [402C], a first updated set of context aware tokens [404C] and a second updated set of context aware tokens [406C], respectively.

More particularly, [402] depicts at [402A] a user input ‘Jeans’ in a search engine is received. Thereafter, at [402B] various autosuggested queries based on the received user input ‘Jeans’ are recommended. Further, at [402C], the set of context aware tokens based on the user input ‘Jeans’ are recommended.

Further [404] depicts at [404A] a user query ‘Jeans Men’ in the search engine is received based on a user selection of ‘Men’ i.e. target context aware token. Thereafter, at [404B] various autosuggested queries based on the received user input/query ‘Jeans Men’ are recommended. Further, at [402C], the first updated set of context aware tokens based on the user query ‘Jeans Men’ are recommended.

Further [406] depicts at [406A] an updated user query ‘Jeans Men Slim’ in the search engine is received based on a user selection of ‘Slim’ i.e. updated context aware token. Thereafter, at [406B] various autosuggested queries based on the received updated user input/query ‘Jeans Men Slim’ are recommended. Further, at [406C], the second updated set of context aware tokens based on the user query ‘Jeans Men Slim’ are recommended.

In an implementation the user query is updated on each selection of updated/changed/new context aware token till a final search action is performed by the user.

Thus, the present invention provides a novel solution for generating a user query based on a target context aware token. The present invention also provides a solution to update a generated user query based on a user selection of one or more updated context aware tokens. Also, the present invention provides a solution to provide one or more autosuggested queries/suggestions based on at least one of a user input, a generated user query and one or more updated user queries.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for generating a user query based on a target context aware token, the method comprising:
initiating, by a processing unit [102], a search engine at a user device;
receiving, via an input unit [104], a user input at the search engine;
recommending, by the processing unit [102], a set of context aware tokens based at least on the user input, wherein the set of context aware tokens comprises a plurality of context aware tokens;
selecting, by the processing unit [102], a target context aware token from the plurality of context aware tokens based on a user selection of the target context aware token;
appending, by the processing unit [102], the target context aware token to the user input in the search engine; and
generating, by the processing unit [102], the user query based on appending the target context aware token to the user input.

2. The method as claimed in claim 1, wherein the search engine is initiated at an e-commerce platform on the user device.

3. The method as claim in claim 1, wherein the plurality of context aware tokens are generated based on:
identifying, by the processing unit [102], one or more whitelisted attributes in the user input;
identifying, by the processing unit [102], a set of attributes corresponding to each attribute of the one or more whitelisted attributes based at least on a pre-defined store mapping dataset;
determining, by the processing unit [102], one or more attribute-attribute pairs based on the identification of the set of attributes corresponding to each attribute of the one or more whitelisted attributes;
determining, by the processing unit [102], a set of values associated with the each attribute-attribute pair and a corresponding score of the each attribute-attribute pair;
determining, by the processing unit [102], all values associated with the each attribute of the one or more whitelisted attributes and a similarity score corresponding to said each attribute based on a knowledge graph;
merging, by the processing unit [102], the set of values associated with each attribute-attribute pair and the corresponding score of the each attribute-attribute pair with the all values associated with the each attribute of the one or more whitelisted attributes and the similarity score; and
generating, by the processing unit [102], the set of context aware tokens based on the merging.

4. The method as claimed in claim 1, the method further comprises providing by the processing unit [102], one or more autosuggested queries based on at least one of the user input and the user query.

5. The method as claimed in claim 1, the method comprises dynamically updating by the processing unit [102], the set of context aware tokens based on the user query to generate an updated set of context aware tokens, wherein the updated set of context aware tokens comprises at least, one or more updated context aware tokens.

6. The method as claim in claim 5, wherein the one or more updated context aware tokens are generated based on one or more whitelisted attribute present in the user query.

7. The method as claimed in claim 5, the method comprises:
selecting, by the processing unit [102], an updated context aware token from the updated set of context aware tokens based on a user selection of the updated context aware token;
appending, by the processing unit [102], the updated context aware token to the user query in the search engine;
modifying, by the processing unit [102], the user query based on appending the updated context aware token to the user query; and
generating, by the processing unit [102], an updated user query based on the modified user query.

8. The method as claimed in claim 2, the method comprises recommending by the processing unit [102] an initial set of context aware tokens based on initiating the search engine at the user device, wherein the initial set of context aware tokens comprises a plurality of recommended whitelisted attributes.

9. The method as claimed in claim 8, wherein the plurality of recommended whitelisted attributes are determined based on a score associated with each recommended whitelisted attribute.

10. A system for generating a user query based on a target context aware token, the system comprising:
a processing unit [102] configured to initiate a search engine at a user device; and
an input unit [104] configured to receive a user input at the search engine, wherein the processing unit [102] is further configured to:
recommend a set of context aware tokens based at least on the user input, wherein the set of context aware tokens comprises a plurality of context aware tokens;
select a target context aware token from the plurality of context aware tokens based on a user selection of the target context aware token;
append, the target context aware token to the user input in the search engine; and
generate, the user query based on appending the target context aware token to the user input.

11. The system as claimed in claim 10, wherein the search engine is initiated at an e-commerce platform on the user device.

12. The system as claim in claim 10, wherein the processing unit [102] to generate the plurality of context aware tokens is configured to:
identify one or more whitelisted attributes in the user input;
identify a set of attributes corresponding to each whitelisted attribute of the one or more whitelisted attributes based at least on a pre-defined store mapping dataset;
determine one or more attribute-attribute pairs based on the identification of the set of attributes corresponding to each attribute of the one or more whitelisted attributes;
determine a set of values associated with the each attribute-attribute pair and a corresponding score of the each attribute-attribute pair;
determine all values associated with the each attribute of the one or more whitelisted attributes and a similarity score corresponding to said each attribute based on a knowledge graph;
merge the set of values associated with each attribute-attribute pair and the corresponding score of the each attribute-attribute pair with the all values associated with the each attribute of the one or more whitelisted attributes and the similarity score; and
generate the set of context aware tokens based on the merging.

13. The system as claimed in claim 10, wherein the processing unit [102] is further configured to provide one or more autosuggested queries based on at least one of the user input and the user query.

14. The system as claimed in claim 10, wherein the processing unit [102] is further configured to dynamically update the set of context aware tokens based on the user query to generate an updated set of context aware tokens, wherein the updated set of context aware tokens comprises at least, one or more updated context aware tokens.

15. The system as claim in claim 14, wherein the one or more updated context aware tokens are generated based at least on one or more whitelisted attributes present in the user query.

16. The system as claim in claim 14, wherein the processing unit [102] is further configured to:
select an updated context aware token from the updated set of context aware tokens based on a user selection of the updated context aware token;
append the updated context aware token to the user query in the search engine;
modify the user query based on appending the updated context aware token to the user query; and
generate an updated user query based on the modified user query.

17. The system as claim in claim 11, wherein the processing unit [102] is further configured to recommend an initial set of context aware tokens based on initiating the search engine at the user device, wherein the initial set of context aware tokens comprises a plurality of recommended whitelisted attributes.

18. The system as claim in claim 17, wherein the plurality of recommended whitelisted attributes are determined based on a score associated with each recommended whitelisted attribute.
